(19) United States
(12) Patent Application Publication
(10) Pub. No.: US 2009/0235130 A1
(43) Pub. Date: Sep. 17, 2009

(54) TEST PATTERN CUSTOMIZATION OF HIGH SPEED SAS NETWORKS IN A MANUFACTURING TEST SYSTEM

(75) Inventors: Brian J. Cagno, Tucson, AZ (US); Gregg S. Lucas, Tucson, AZ (US); Thomas S. Truman, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/048,766

(22) Filed: Mar. 14, 2008

(51) Int. Cl. H04B 17/00; G06F 11/00

(52) U.S. Cl. 714/715; 714/E11.002

(57) ABSTRACT

A method for testing a high-speed serial interface, comprising: generating a customized stress test pattern configured to violate an 8bit/10bit-encoding scheme into an expander, the customized stress test pattern is configured to stress the high-speed serial interface beyond marginal limits resulting in less testing to force errors within the high-speed serial interface; transmitting the customized stress test pattern from a transmit port of a first serializer/deserializer device of the high-speed serial interface; and monitoring a receive port of a second serializer/deserializer device to detect errors within the high-speed serial interface.

### BACKGROUND OF THE INVENTION

1. Field of the Invention

This invention relates to storage networks, and particularly to systems and methods for reducing the execution time of test patterns by generating customized test patterns within a high-speed network in a manufacturing test system.

2. Description of Background

Over the past decade, a transition has taken place as to the preferred method for implementing high throughput data links. Traditionally, high-speed interfaces over relatively short distances were implemented using wide parallel buses, such as peripheral component interface extended (PCI-X), which contains a 64-bit wide data bus. More recent implementations use high-speed serial links, such as Fibre Channel or serial attached SCSI (SAS), which usually only contain two bidirectional differential high-speed pairs. In order to get the same data throughput as the wide parallel buses over a serial interface, the speed at which the data is transferred is dramatically increased, with recent speeds for Fibre Channel reaching 8 GHz and SAS reaching 6 GHz. This increase in speed presents vastly different challenges for testing in a manufacturing environment as compared to the wide parallel buses, which may only run at 133 MHz, as an example.

The typical measurement for determining if a high-speed differential serial interface is acceptable is bit error rate (BER). Allowable limits for BER may be one error in 10¹² data bits. Most system designs have margin designed into them that greatly surpass the 1×10⁻¹², which makes testing too long to be feasible for the manufacturing environment. Existing methods simply employ wrap back testing with attenuators to reduce the designed-in margin. The problem with this methodology is that it does not allow for component variation, nor for defects in manufacturing of the printed circuit board.

If the designs are robust, it may not only take many patterns but many types of patterns to screen for all types of performance defects. Generally, the defects manifest themselves as jitter, noise and BER failures. It should be appreciated that an increased number of test patterns will result in correspondingly longer test times, which will drive up the cost of testing the product and ultimately will increase the product cost.

### SUMMARY OF THE INVENTION

The shortcomings of the prior art are overcome and additional advantages are provided through the provision of a method for testing a high-speed serial interface, comprising: generating a customized stress test pattern configured to violate an 8bit/10bit-encoding scheme into an expander, the customized stress test pattern is configured to stress the high-speed serial interface beyond marginal limits resulting in less testing to force errors within the high-speed serial interface; transmitting the customized stress test pattern from a transmit port of a first serializer/deserializer device of the high-speed serial interface; and monitoring a receive port of a second serializer/deserializer device to detect errors within the high-speed serial interface.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for reducing the execution time of test patterns by generating customized test patterns that violate the standard encoding protocol within a high-speed network in a manufacturing test system.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a schematic block diagram of a high-speed SAS network comprising a controller card in a manufacturing test system in accordance with one exemplary embodiment of the present invention;

FIG. 2 illustrates a schematic block diagram of the transmission of data between one SerDes circuit to another SerDes circuit of the controller card in accordance with one exemplary embodiment of the present invention; and

FIG. 3 is a flowchart diagram illustrating a high-speed serial interface testing method in accordance with one exemplary embodiment of the present invention.

The detailed description explains the preferred embodiments of the invention, together with advantages and features, by way of example with reference to the drawings.

### DETAILED DESCRIPTION OF THE INVENTION

The present invention and the various features and advantageous details thereof are explained more fully with reference to the non-limiting embodiments that are illustrated in the accompany drawings and detailed in the following description. It should be noted that the features illustrated in the drawings are not necessarily drawn to scale. Descriptions of well-known or conventional components and processing techniques are omitted so as to not necessarily obscure the present invention in detail. The examples used herein are intended merely to facilitate an understanding of ways in which the invention may be practiced and to further enable those of skill in the art to practice the invention. Accordingly, the examples should not be construed as limiting the scope of the invention.

The inventors herein have recognized that by creating a customized test pattern, which is outside the standard testing protocol (8-bit/10-bit encoding scheme) significantly reduces the execution time of performance stress testing while still maintaining full functional test coverage for potential component and assembly defects. The inventors herein have further recognized that violating the standard testing protocol stresses the SAS interface beyond normal limits resulting in less testing to force a failure and to detect subtle or marginal defects in the SAS interface. The inventors herein have recognized that such an approach is much more effective than increasing the signal amplitude beyond the specification.

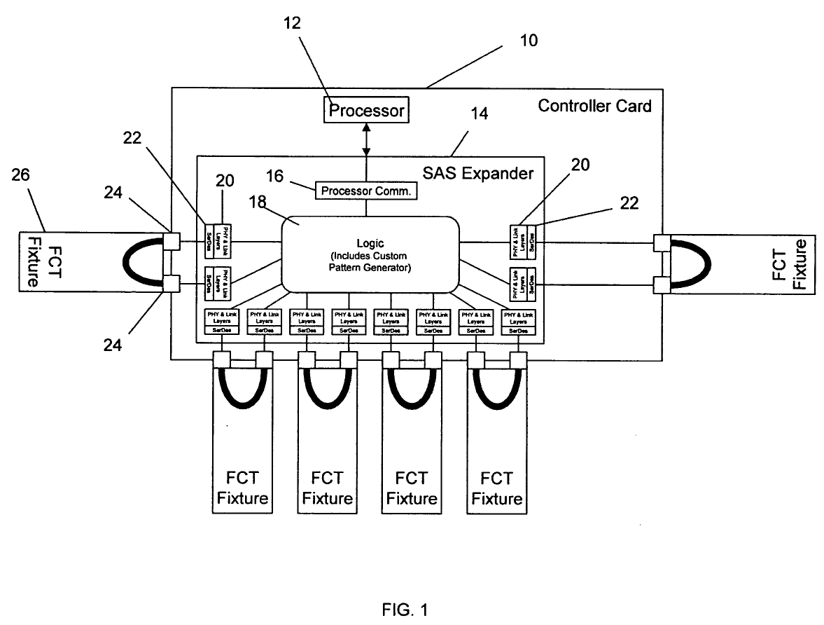

For a better understanding of the invention and its operation, turning now to the drawings, FIG. 1 is a schematic block diagram of a high-speed SAS network comprising a controller card or card under test 10 in a manufacturing test system environment in accordance with one exemplary embodiment. The network configuration shown in FIG. 1 is a non-limiting application system used in accordance with one exemplary embodiment. The controller card 10 includes a processor 12 and a SAS expander 14, which comprises a processor communication device 16, a logic controller 18, a number of physical and link layers (PHY and Link Layers) 20 coupled with transmitter and receiver circuits, also known as serializer/deserializer (SerDes) circuits 22. In accordance with one exemplary embodiment, the processor 12 and the SAS expander 14 have bidirectional communication with one another including the components (e.g., physical and link layer) of the SAS expander.

In one exemplary embodiment, the controller card 10 includes SAS ports 24 or connectors for forming a serial data transmission path from one SerDes circuit to another SerDes circuit using high-speed SAS cables. The SAS ports 24 are configured to provide high-speed interconnection to external devices (e.g., server). The SAS ports 24 can be any type of connector (e.g., fiber channel) compatible with the interface. In one non-limiting exemplary embodiment, the controller card 10 includes 12 SAS ports. Of course, the controller card 10 can include more or less than 12 SAS ports in accordance with exemplary embodiments of the present invention. As shown, only one SAS port is communicatively coupled to one of the SerDes circuits. However, it should be understood that one SAS port is configured to support data transmission for the transmitter and receiver end of each SerDes circuit in accordance with one exemplary embodiment. It is contemplated that two separate SAS ports support the transmitter and receiver end of each SerDes circuit respectively in accordance with one exemplary embodiment.

A Functional Card Test (FCT) fixture 26 can be used to support the cabling between the SAS ports of the controller card end in accordance with one exemplary embodiment. In another exemplary embodiment, a wrap cable can be used to create a serial data transmission path between SerDes circuits. Such path provides a medium for transmitting a customized test pattern to test the controller card 10. In accordance with one exemplary embodiment, the FCT fixture 26 also includes SAS ports for facilitating the transmission of data from one SerDes to another SerDes.

In accordance with one exemplary embodiment, the processor 12 is communicatively coupled to the processor communication device 16 of the SAS expander 14. The processor 12 operably sends commands to the processor communication device 16 of the SAS expander 14 to instruct the SAS expander to create or program a customized test pattern that violates the conventional 8-bit/10-bit encoding scheme. The processor 12 can be any custom made or commercially available processor configured for carrying out the methods and/or functions described herein. In one exemplary embodiment, the processor 12 comprises a combination of hardware and/or software/firmware with a computer program that, when loaded and executed, permits the processor 12 to operate such that it carries out the methods described herein.

The processing communication device 16 of the SAS expander 14 effectively overrides the conventional SAS protocol checked by the transmission firmware of the SAS expander in order to allow a customized stress pattern to be transmitted. In accordance with one exemplary embodiment, the conventional SAS protocol is checked by the transmission firmware of the SAS expander but can be overridden by either turning off the checking or masking the error flag through the processing communication device 16.

The logic controller 18 is communicatively coupled to the processing communication device 16 and is configured to route or interconnect any SAS port to another SAS port. In accordance with one exemplary embodiment, the logic controller 18 includes a custom pattern generator for programming a stress pattern customized to violate the 8bit/10bit-encoding scheme for testing the controller card 10. The logic controller 18 comprises a combination of hardware and software/firmware for carrying out the methods described herein.

The customized stress test pattern violates the 8-bit/10-bit encoding scheme by having a pattern that has more than three zeros (0) in succession (zero disparity) and/or more than three ones (1) in succession (ones disparity). This customized stress test pattern allows subtle or marginal defects (e.g., dust, poor soldering, etc.) present within the controller card to be detected. The customized stress test pattern is configured to stress the high-speed interface (controller card) beyond conventional stress limits resulting in less testing (e.g., approximately 30 seconds to 60 seconds) to force a failure or error within the high-speed interface. In other words, the predefined specification of the 8-bit/10-bit encoding scheme is exacerbated beyond specified limits or marginal limits. Marginal limits are those limits which intrude on the standardized eye mask boundaries as defined by the specific technology (e.g., SAS, Fiber Channel). The customized test pattern introduces a lower frequency than the convention 8-bit/10-bit encoding scheme. As such, the Inter Symbol Interference (ISI) component of deterministic jitter in the signal will greatly increase, thus providing jitter margin testing as well. In accordance with one exemplary embodiment, the processor 12 calibrates the results of the customized stress test pattern to account for the induced jitter.

The physical and link layer devices 20 are correspondingly coupled with the SerDes circuits 22. Each physical and link layer configures the corresponding SerDes circuit to transmit and receive the invalid pattern or customized stress pattern. In accordance with one exemplary embodiment, the physical and link layers are a lower-level protocol above the SerDes circuits.

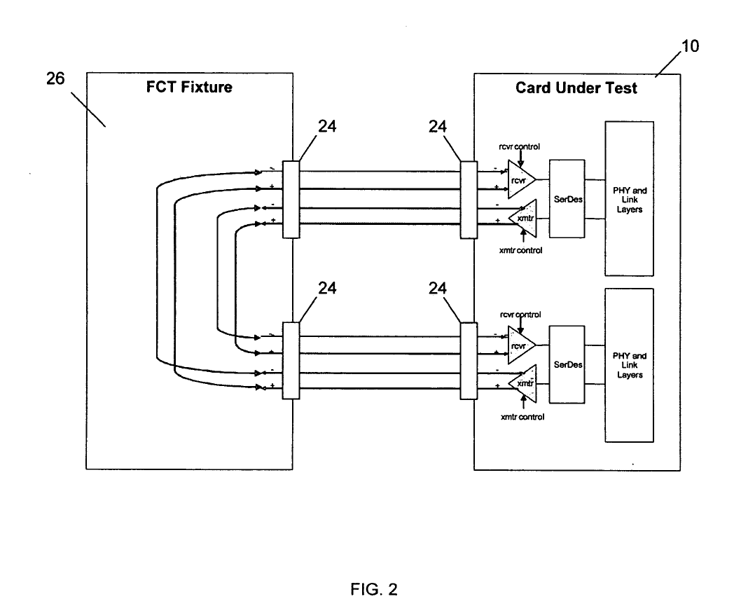

The SerDes circuits each facilitate the transmission of parallel data between two SAS ports over serial streams. The transmitter of each of the SerDes circuits converts the parallel data to serial data. In contrast, the receiver of each of the SerDes circuits converts the serial data back to parallel data. In accordance with one exemplary embodiment, the customized test pattern is sent from the transmitter of one SerDes and is transmitted between one SAS port to another SAS port and effectively to the receiver of another SerDes. FIG. 2 better illustrates the transmission of data between one SerDes circuit to another SerDes circuit. For ease of discussion, only two physical and link layer/SerDes circuit arrangements are shown on the controller card 10. However, it should be understood that additional physical and link layer/SerDes circuit arrangements could be part of the controller card 10 as shown in FIG. 1. The other components of the SAS expander 14 are also not illustrated in FIG. 2 for ease of discussion.

In operation, the customized test pattern is sent through the transmitter (xmtr) of one SerDes circuit and received at the receiver (rcvr) of another SerDes Circuit via a high-speed cable between the SAS ports as shown in FIG. 2. In accordance with one exemplary embodiment, the processor 12 monitors the receiver of the SerDes for errors. If errors are detected, the operator is informed via an indicating device (e.g., computer screen) that the controller card failed the customized stress test pattern in accordance with one exemplary embodiment. Then the controller card can be decoupled from the FCT fixture 26 for further debug while another controller card is tested. If errors are not detected after the time elapsed (execution time of the customized test pattern), the operator is informed via the indicating device that the controller card passed. The card will not be considered as a passed card unless the test time or execution time of the customized stress test pattern has elapsed.

In accordance with one exemplary embodiment, the indicating device is coupled to the processor. It is contemplated that a graphical representation of the customized stress test is displayed in the indicating device to illustrate the limits of the customized test patterns in comparison to the conventional 8-bit/10-bit encoding scheme. As such, an analysis tool, such as a Wavecrest, could be used to define and calibrate the stress conditions.

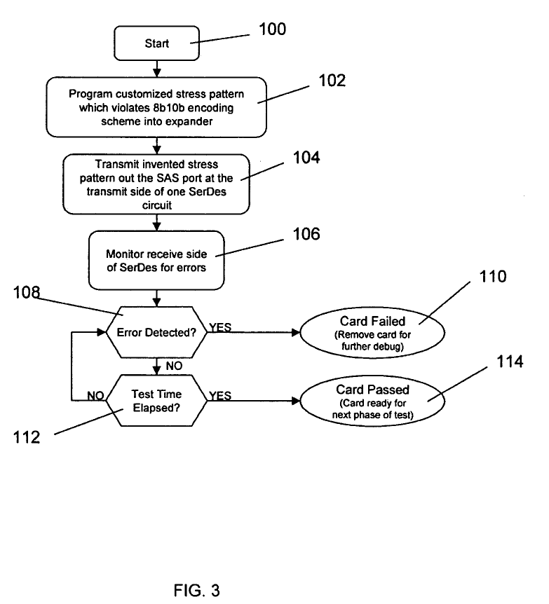

Turning now to FIG. 3, a flowchart diagram illustrates a high-speed serial interface testing method in accordance with an exemplary embodiment of the present invention. As can be appreciated, in light of the disclosure, the order or operation within the method is not limited to the sequential execution as illustrated in FIG. 3, but may be performed in one or more varying orders in accordance with the present disclosure. As shown in the example of FIG. 3, the method is run continually during processor operation and only exits when processor operation ceases.

In one example, the method begins at block 100. A customized stress pattern is programmed, which violates the 8-bit/10-bit encoding scheme into the expander, as shown at block 102. The customized stress pattern is then transmitted out the SAS ports at the transmit side of one SerDes circuit, as shown at block 104. At block 106, the receive side of another SerDes is monitored for errors, followed by a determination of whether errors are detected at decision block 108. If errors are detected, the method indicates that the card failed at block 110. Optionally, the card can be removed for further debug. If no errors are detected, it is further determined if the test time has elapsed at block 112. If the answer is no, then the method returns to block 108. If the answer is yes, the method indicates that the card passed at block 114.

In accordance with one embodiment, the method described above is implemented for each SerDes circuit in the controller card 10. In other words, the transmitter and the receiver end of each SerDes are tested using the method described above.

Advantageously, the intent of exemplary embodiments of the present invention is to reduce the execution time of the test patterns and maintain the test and cost effectiveness for the high BER performance.

It should be understood that each block of the flowchart illustrations, and combinations of blocks in the flowchart illustrations, can be implemented by computer program instructions. These computer program instructions may be provided to a processor or other programmable data processing apparatus to produce a machine, such that the instructions, which execute on the processor or other programmable data processing apparatus create means for implementing the functions specified in the flow chart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combination of blocks in the flowchart illustrations, can be implemented by special purpose hardware-based computer systems which perform the specified functions or steps, or by combinations of special purpose hardware and computer instructions.

Furthermore, the flowcharts are provided to demonstrate the operations performed within the illustrative embodiments. The flowcharts are not meant to state or imply limitations with regard to the specific operations or, more particularly, the order of the operations. The operations of the flowcharts may be modified to suit a particular implementation without departing from the spirit and scope of the present invention.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for testing a high-speed serial interface, the method comprising:
generating a customized stress test pattern configured to violate an 8-bit/10-bit encoding scheme into an expander, the customized stress test pattern configured to stress the high-speed serial interface beyond marginal limits resulting in less testing to force errors within the high-speed serial interface;
transmitting the customized stress test pattern from a transmit port of a first serializer/deserializer device of the high-speed serial interface; and
monitoring a receive port of a second serializer/deserializer device to detect errors within the high-speed serial interface.

2. The method as in claim 1, further comprising:
transmitting the customized stress pattern from a transmit port of the second serializer/deserializer device; and
monitoring a receive port of the first serializer/deserializer device to detect subtle errors within the high-speed serial interface.

3. The method as in claim 1, where the customized stress test pattern has more than three logical zeros in succession.

4. The method as in claim 1, wherein the customized stress test pattern has more than three logical ones in succession.

5. The method as in claim 1, wherein the customized stress test pattern is configured to detect subtle component and assembly defects within the high-speed serial interface.
